(19) United States
(12) Patent Application Publication
(10) Pub. No.: US 2022/0339590 A1
(43) Pub. Date: Oct. 27, 2022

(54) MIXER, METHOD OF MANUFACTURE OF A MIXER, DISPENSING ASSEMBLY AND METHOD OF DISPENSING MATERIALS

(71) Applicant: Sulzer Mixpac AG, Haag (CH)

(72) Inventors: Hayden TURNER, Ayer, MA (US); Victor CLEMENS, Buchs (CH)

(21) Appl. No.: 17/620,823

(22) PCT Filed: Jun. 24, 2020
(86) PCT No.: PCT/EP2020/067591

§ 371 Date: Dec. 20, 2021

(30) Foreign Application Priority Data
Jun. 28, 2019 (EP) 19183147.8

(51) Int. Cl. B01F 33/501; B01F 35/22; B05C 17/005; B05C 17/01

(52) U.S. Cl. CPC B01F 33/50112; B01F 33/50114; B01F 35/2207; B05C 17/00566; B05C 17/0103; B01F 2101/2305

(57) ABSTRACT

A mixing tip for mixing multi-component materials exiting a multi-component cartridge includes a code that is stored in or at the mixing tip indicating at least one of a type of mixing tip, a manufacturer of the mixing tip, a date of production of the mixing tip and a list of materials compliant with the mixing tip.

### CROSS-REFERENCE TO RELATED APPLICATIONS

This application is a U.S. National Stage application of International Application No. PCT/EP2020/067591, filed Jun. 24, 2020, which claims priority to European Patent Application No. 19183147.8, filed Jun. 28, 2019, the contents of which are hereby incorporated herein by reference.

### BACKGROUND

### Field of the Invention

The present disclosure relates to a mixer for mixing multi-component materials exiting a multi-component cartridge, wherein a code is stored in or at the mixer indicating at least one of a type of mixer, a manufacturer of the mixer, a date of production of the mixer and a list of materials compliant with the mixer. The disclosure further relates to a method of manufacture of a mixer, to a dispensing assembly and to a method of dispensing materials via said mixer.

### Background Information

Conventional static mixers and dynamic mixers, respectively mixing tips as they are also known as, are used to mix multi-component material dispensed from a multi-component cartridge. Such mixing tips are used in a plethora of fields of application ranging from industrial applications, such as the use of adhesives to bond structural components one to another, or as protective coatings for buildings or vehicles, to medical and dental applications, for example, to make dental molds.

The multi-component material is, for example, a two-component adhesive comprising a filler material and a hardener. In order to obtain the best possible mixing result, e.g. an adhesive having the desired bond strength, the multi-component material has to be thoroughly mixed.

For this purpose the mixing tips comprise several structures and/or mixing segments arranged one after the other that repeatedly divide and re-combine part flows of the multi-component material to thoroughly mix the multi-component material.

The number and size of the respective structures and/or mixing segments and hence of the mixing tip is typically selected in dependence on the actual multi-component material to be mixed, i.e. different lengths and sizes of mixing tips exist for different types of materials.

### SUMMARY

It has been found that if on mixing the multi-component material the wrong size is selected this can lead to various disadvantageous results. Firstly, if too small a mixing tip is selected the multi-component material will not be mixed thoroughly enough such that the resultant bond, if an adhesive is mixed, will not have the desired strength and could therefore fail prematurely.

Secondly, if too large a mixing tip is selected, the volume of material remaining in the static mixer after the dispensing process has completed is larger than need be. This larger than required volume is then generally discarded as it remains in the mixing tip.

Depending on the field of application the multi-component material can be comparatively expensive and can only be used for one application at a time, with a multi-component cartridge storing materials for 5 or more, preferably 10 or more such applications. This is particularly true, for example in the dental field, where only part of the multi-component material stored in the cartridge is used for one application/patient at a time with the remaining multi-component material being stored in the multi-component cartridge for future applications. Thus, the excessive use of large volumes of multi-component material remaining in a static mixer after a single use leads to unnecessary cost.

For this reason it is an object of embodiments of the present invention to provide a mixing tip with which one can ensure the desired mixing efficiency, with the mixing efficiency being a balance between low waste volume, and a good mixing quality. It is a further object of embodiments of the invention to make available a static mixer that can be produced in an as facile manner as possible.

This object is satisfied by a mixing segment having the features described herein.

Such a mixing tip for mixing multi-component materials exiting a multi-component cartridge, the mixing tip comprising:

an inlet end having a respective inlet for each of the multi-component materials, the inlet end being configured to be releasably coupled to the multi-component cartridge;

an outlet end having an outlet for dispensing the mixed multi-component materials; and

a mixing element arranged between the inlet end and the outlet end in a housing of the mixing tip, the mixing element being provided for mixing the multi-component materials on their passage between the inlet end and the outlet end,

wherein a readable code is stored in or at the mixing tip, said readable code indicating at least one of a type of mixing tip, a manufacturer of the mixing tip, a date of production of the mixing tip, a length of the mixing tip, a diameter of the mixing tip, a size of the mixing tip and a list of materials compliant with the mixing tip, a compatibility of the mixing tip with cartridge contents, and a list of applications compliant with the mixing tip.

By providing a readable code at the mixing tip which comprises information relating to properties of the mixing tip a check can be made on installing the mixing tip at a cartridge whether the mixing tip is suitable for use with the contents of the cartridge at the desired mixing efficiency.

Furthermore, embedding the code within a part of the mixing tip or attaching it to a part of the mixing tip means that the method of manufacture only has to be altered slightly and one thereby makes available a static mixer that can be produced in an as facile manner as possible, with the mixing tip being able to be used in applications which ensure the desired mixing efficiency.

The code can be stored at an element that is embedded within the housing or is attached to the housing of the mixing tip. By storing the code at an element the code can be protected against environmental influences that are present, e.g. during the injection molding process or 3D printing process that can be used to form the mixing tip or during the use of the dispenser, such as water if the dispenser is used at e.g. bridges for the repair or construction thereof etc.

The code can be one of a hologram, a QR code, an NFC code, a barcode, and an RFID code. Such codes can store several pieces of information such as the ones detailed above and can be read out in an expedient manner using known technologies.

The mixing tip can be one of a dynamic mixer and a static mixer. Such mixing tips can be used in a plethora of mixing applications.

The mixing element can be a one piece mixing element or a series of several separate mixing element segments combined to one mixing element in the housing of the mixing element. In this way the mixing element can be tailored to a desired material to be mixed therein.

The mixing tip can comprise a bottom housing part surrounding the inlets at the inlet end with the code being arranged in or at the bottom housing part, the bottom housing part optionally being arranged, in particular directly, adjacent to a tubular housing part, with the tubular housing part optionally tapering at the outlet end towards the outlet. Applying the code at the bottom housing part ensures that a code reader installed at a dispenser can be arranged as close as possible to the code at the mixing tip.

The code can be arranged in or at a tubular housing part of the housing, with the tubular housing part being configured to store and receive at least 30%, preferably at least 80% of the mixing element. In this way the code is arranged remote from the part of the mixing tip which comprises the connection to the cartridge and possibly also to the dispenser.

A length of the tubular housing part can be at least 40%, preferably at least 60% and up to 75% of a distance between the outlet and the inlets along a longitudinal axis of the mixing tip. Similarly a length of the bottom housing part is preferably selected as being between 5% and 25% of a distance between the outlet and the inlets along a longitudinal axis of the mixing tip.

According to a further aspect embodiments of the present invention relate to a method of manufacturing a mixing tip, the method comprising the steps of:

forming the mixing tip;

providing the code at or in the mixing tip before, during or after the step of forming the mixing tip; and

validating the code following the completion of the mixing tip. In this way one can reliably ensure that codes possibly destroyed during the manufacture of the mixing tip are not distributed with the mixing tips to customers etc.

The step of forming the mixing tip can comprise one of injection molding the mixing tip and 3D printing the mixing tip. Such methods of manufacture are known to reliably and expediently form the desired mixing tips.

According to a further aspect embodiments of the present invention relate to a dispensing assembly comprising a mixing tip, a multi-component cartridge, optionally filled with respective multi-component materials, a dispenser and a controller, the dispenser being adapted to bring about dispensing of the multi-component materials from the multi-component cartridge via the mixing tip, the dispenser further comprising a code reader for reading the code stored in or at the mixing tip, the controller being connected to the code reader and being adapted to evaluate the code stored in or at the mixing tip.

The multi-component cartridge can thus be filled with materials selected from the group of members consisting of topical medications, medical fluids, wound care fluids, cosmetic and/or skin care preparations, dental fluids, veterinary fluids, adhesive fluids, disinfectant fluids, protective fluids, paints and combinations of the foregoing.

Such fluids and hence the dispensing assembly can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively the fluids and hence the dispensing assembly can also be used in an industrial sector both for the production of products as well as for the repair and maintenance of existing products, e.g. in the building industry, the automotive industry, the aerospace industry, in the energy sector, e.g. for windturbines, etc. The dispensing assembly can, for example, be used for the dispensing of construction material, sealants, bonding material, adhesives, paints, coatings and/or protective coatings.

The controller can be arranged at or in a housing of the dispenser. In this way the best position for the controller can be selected in dependence on the design of the dispenser.

The multi-component cartridge can further comprise a cartridge code stored in or at a housing of the multi-component cartridge, the cartridge code indicating at least one of a material of the multi-component cartridge, a volume of the multi-component material, a manufacturer of the multi-component cartridge, a date of production of the multi-component cartridge, a list of applications compliant with the cartridge, a list of mixing tips compliant with the cartridge, and a compatibility of the cartridge with a mixing tip, wherein the dispenser comprises a code reader, optionally the code reader provided for reading the code stored in or at the mixing tip or a separate code reader, the code reader being adapted to read out the cartridge code and the controller being adapted to evaluate the cartridge code. By having a cartridge code and forming the dispenser such that it can read the code stored at the cartridge one can ensure that the correct type of mixing tip is selected for use with the materials stored in the multi-component cartridge in order to achieve the desired mixing efficiency.

The controller can be adapted to output at least some of the information stored in the code and/or the cartridge code.

According to a further aspect embodiments of the present invention relate to a method of dispensing multi-component materials using a mixing tip and/or a dispensing assembly, the method comprising the steps of:

installing the multi-component cartridge at the dispenser;

fixing the mixing tip to the multi-component cartridge;

reading out the code stored in or at the mixing tip;

optionally reading out a cartridge code stored in or at the multi-component cartridge; and

indicating at least some of the information stored in the code and/or the cartridge code before a use of the dispenser.

In this way e.g. the compliance of the mixing tip with a material stored in the cartridge can be indicated to a user of the dispensing assembly in order to verify if the correct mixing tip is being used for the materials stored in the cartridge in order to ensure the desired mixing efficiency.

The step of reading out the code stored in or at the mixing tip can further comprise the reading out of the cartridge code. In this way information stored in the code relating to the mixing tip can be compared with information stored in the cartridge code relating to the cartridge and its contents, with at least some of the information being able to be displayed at the dispenser.

### BRIEF DESCRIPTION OF THE FIGURES

The invention will be explained in more detail hereinafter with reference to the drawings.

FIG. 1 is a schematic perspective view of a dispensing system;

FIG. 2 is a schematic sectional view of an automatic mixing unit;

FIG. 3 is a perspective view of a dispenser;

FIG. 4 is a perspective view of a cartridge; and

FIG. 5 is a schematic part sectional view of a further mixing tip.

### DETAILED DESCRIPTION

In the following the same reference numerals will be used for parts having the same or equivalent function. Any statements made having regard to the direction of a component are made relative to the position shown in the drawing and can naturally vary in the actual position of application.

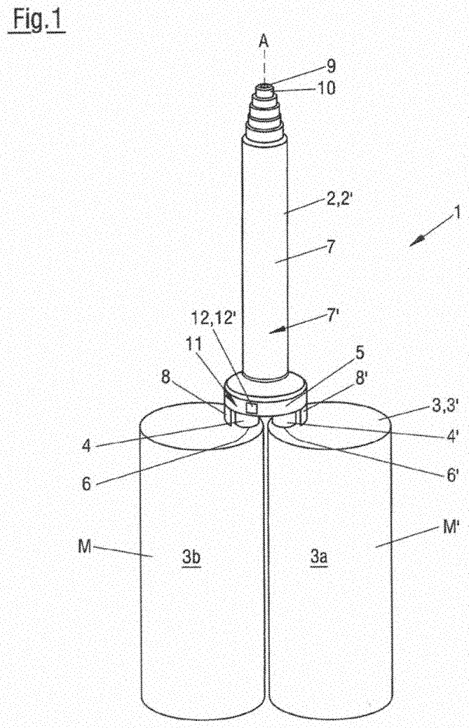

FIG. 1 schematically shows a dispensing system 1 comprising a static mixer 2, also known as a mixing tip 2′, and a multi-component cartridge 3. The multi-component cartridge 3 shown in FIG. 1 is a two-component cartridge 3′ having two cartridge chambers 3a, 3b that are filled with respective two-component materials M, M′, for example, a hardener and a binder material.

The static mixer 2 comprises two inlets 4, 4′ at a first end 5 thereof. The two inlets 4, 4′ connect to two outlets 6, 6′ of the two-component cartridge 3′. In the present example the inlets 4, 4′ receive the outlets 6, 6′ of the two-component cartridge 3′. It should be noted in this connection that other forms of interaction between the inlets 4, 4′ and the outlets 6, 6′ are possible.

A housing 7 of the schematically illustrated static mixer 2 further comprises an alignment means (aligner) 8, 8′ that enable a correct alignment of the inlets 4, 4′ of the static mixer 2 relative to the outlets 6, 6′ of the two-component cartridge 3′. The alignment means 8, 8′ can for example be configured as bayonet-like connection means (not shown) and hence also act as a kind of attachment means (not shown) to attach the static mixer 2 to the two-component cartridge 3′. Other kinds of attachment means (also not shown) such as a locking ring can also be used and are well known to the person skilled in the art.

The housing 7 further has a dispensing outlet 9 at a second end 10 (also known as the outlet end) of the static mixer 2. The mixed multi-component material M, M′ is dispensed via the dispensing outlet 9 following its passage through the static mixer 2. The dispensing outlet 9 is arranged at a longitudinal axis A of the static mixer 2. The longitudinal axis A extends from the inlets 4, 4′ of the static mixer 2 to the outlet 9 of the static mixer 2.

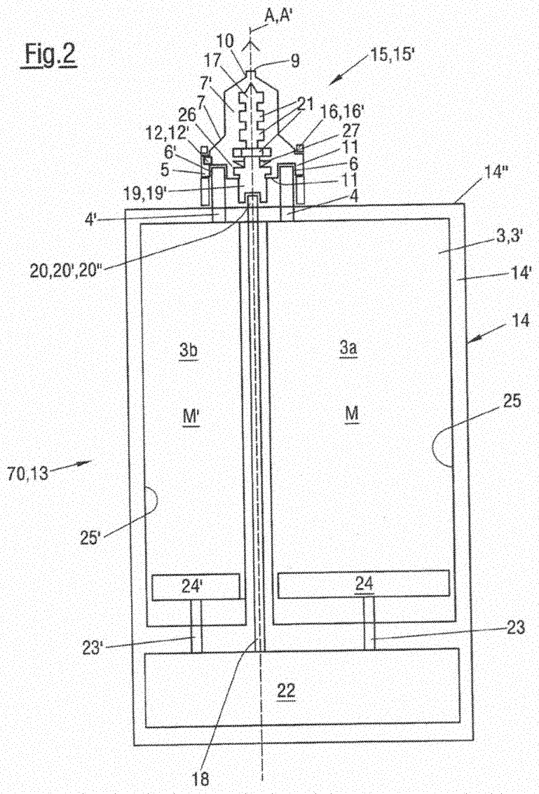

FIG. 2 shows a schematic sectional view of an automatic mixing unit 13 as is used e.g. in dental surgeries to dispense multi-component materials then used to form e.g. dental imprints or molds of a patients' teeth. The automatic mixing unit 13 is also referred to as a dispensing assembly 70.

The automatic mixing unit 13 comprises a housing 14 having a cartridge receptacle 14′ for the multicomponent cartridge 3, in the present instance a two-component cartridge 3′. A dynamic mixer 15 is connected to the two-component cartridge 3′ in a connection region 16 present in the region of the outlets 6, 6′ from the two-component cartridge 3′ and in the region of the inlets 4, 4′ of the dynamic mixer 15 at an end 14″ of the housing 14.

In the present example the connection region 16 comprises a latch 16′ which releasably fixes the dynamic mixer 15 to the two-component cartridge 3′.

Depending on the design of the two-component cartridge 3′, the latch 16′ can be present at the two-component cartridge 3′, as is the case in the present embodiment. Alternatively the latch 16′ can be a part of the housing 14 per se (not shown). Also other attaching means (or device) other than a latch 16′ can be used to attach the dynamic mixer 15 to the two-component cartridge 3′. For example, a retainer nut or the like can hold the dynamic mixer 15 in place at the multi-component cartridge 3.

The dynamic mixer 15 comprises a mixing rotor 17 arranged within a housing 7 of the dynamic mixer 15. The mixing rotor 17 is driven by a drive shaft 18 of the automatic mixing unit 1. On driving the mixing rotor 17 and the drive shaft 18, these both rotate about an axis of rotation A. In this connection it should be noted that the dynamic mixer 15 is frequently also referred to as a mixing tip 15′.

In the dental field the desired direction of rotation of the mixing rotor 17 and hence of the drive shaft 18 is the counter clockwise direction of rotation. In other fields the desired direction of rotation is the clockwise direction of rotation. The mixing rotor 17 discussed in the following can be adapted for both directions of rotation of the mixing rotor 17.

In order to couple the drive shaft 18 to the mixing rotor 17, the mixing rotor 17 comprises a coupling socket 19 also known as a coupling element 19′ into which a coupling end 20 of the drive shaft 18 is inserted. The coupling end 20 of the drive shaft 18 is often also referred to as a coupling plug 20′ also known as a coupling member 20″. It should be noted that in the present example the coupling plug 20′ has a polygonal outer shape, namely that of a regular hexagon.

The drawing shown in FIG. 2 illustrates the coupling element 19′ to be present at the mixing rotor 17 and the coupling member 20″ to be present at the drive shaft 18. It should be noted in this connection that designs are possible in which the coupling element 19′, that is the coupling socket 19, is present at the drive shaft 18 and consequently the coupling member 20″, that is the coupling plug 20′, is present at the mixing rotor 17.

The mixing rotor 17 is driven to mix materials M, M′ originally stored in the two-component cartridge 3′ within the dynamic mixer 15 and to subsequently dispense these via the mixer outlet 9. In order to mix the materials M, M′, the mixing rotor 17 comprises a plurality of mixing vanes 21 that are configured and arranged about the axis of rotation A along the length of the mixing rotor 17.

The automatic mixing unit 13 comprises a drive unit (driver) 22 that is configured to drive the drive shaft 18 and thereby the mixing rotor 17. The drive unit 22 is further configured to drive respective pistons 19, 19′ via piston drive shafts 20, 20′ in order to urge the material M, M′ stored in the two-component cartridge 3′ towards the outlets 6,6′ and thereby into the dynamic mixer 15.

When the automatic mixing unit 13 is activated, the pistons 24, 24′ move along the walls 25, 25′ of the two-component cartridge 3′ in a direction towards the outlets 6, 6′ of the two-component cartridge 3′ in a longitudinal direction A′ of the dynamic mixer 15 that coincides with the axis of rotation A of the mixing rotor 17.

The materials M, M′ are pressed out of the outlets 6, 6′ of the two-component cartridge 3′ and into the inlets 4, 4′ arranged in a region of the bottom housing part 11 of the housing 7 of the dynamic mixer 15. The inlets 4, 4′ guide the material into an antechamber 26 arranged in the region of a rotary surface 27 of the mixing rotor 17. A pre-mixing of the material takes place in the antechamber 26 in the region of the rotary surface 27.

The drive unit 22 and hence the automatic mixing unit 13 can be operated by battery power or can be connected to a mains supply (both not shown).

In this connection it should be noted that the dynamic mixer 15 like the static mixer 2 is a disposable part that can be exchanged after every use or after several uses of the automatic mixing unit 13. Likewise the multi-component cartridge 3, or at least components of the multi-component cartridge 3 is/are (a) disposable part(s) that is/are regularly exchanged.

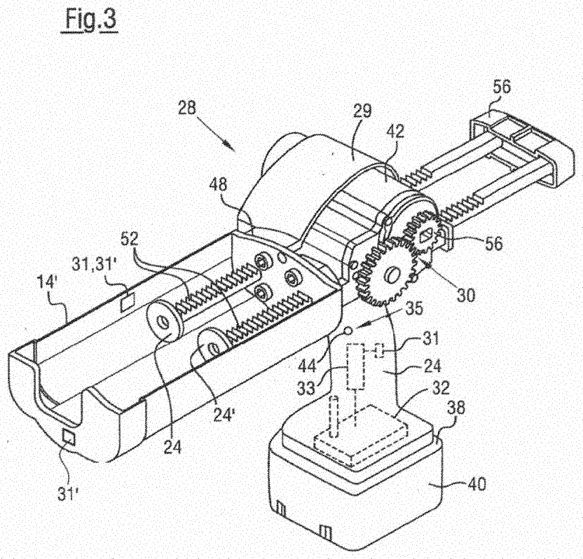

Referring to FIG. 3, a dispenser 28 is illustrated. The dispenser 28 is an electric dispenser and includes a housing 29, a drive unit 30 (also known as an actuation mechanism/actuator), a motor, material dispensers 24′ (also known as piston drive shafts 24), sensors 31, a receiver/transmitter 32 and a controller 33. The housing 29 includes a handle 34 for gripping by an operator for operating the dispenser 28 to dispense material. The handle 34 includes a trigger switch or trigger 35, a speed control dial (SCD—not shown) and an operation mode selection switch in the form of an on/off mode switch in a manner known per se (not shown). The housing 29 accommodates the drive unit 30 and the controller 33. At the bottom 38 of the housing 29, a rechargeable battery pack or power supply 40 is attached in a manner normal for portable electric tools.

Alternatively, the dispenser 28 can include a cord for connection with a power supply such as a power outlet. As is understood, the power supply 40 (e.g., the battery) supplies a voltage to the drive unit or actuation mechanism 30 to operate the dispenser 28.

An indicator 44 can be disposed on the handle 34 for indicating specific conditions. In other words, the indicator 44 can be an LED that indicates one or more of a number of specific conditions such as, temperature, pressure, first dispensing mode activated, second dispensing mode activated, low or full battery charge, overload (torque), high temperature, end-stop switch activated, etc. The indicator 44 can be any other suitable indicator or display to can display any suitable information.

A holder (cartridge receptacle) 14′ is disposed at a front end 48 of the housing 29 to receive the cartridge 3 for material M, M′ to be dispensed. Thus, the holder 14′ defines the front end 48 of the dispenser 28.

The cartridge 3 can be any form of receptacle for material, such as a sausage type cartridge 3 or a solid cartridge 3, or any other suitable type of receptacle. The material M, M′ to be dispensed can be any type of two-component material that is mixed to form a material for the desired application such as a sealant, paint or adhesive.

The dispenser 28 further comprises a rack 52. At the front end of the rack 52 is at least one material dispenser 24′. In one embodiment, the material dispenser 24′ is a first material dispenser of a first material dispenser and a second material dispenser, with each of the material dispensers 24′ being a plunger (connected to a pushrod) configured to be inserted into a respective cartridge chamber 3a, 3b of the cartridge 3. The material dispensers 24′ are configured to drive and dispense the material from the cartridge 3 via the pistons 23, 23′ received in the cartridge 3. Although the material dispensers 24′ are illustrated as plungers, the material dispensers 24′ can be any suitable devices. The rack 52 extends through the drive unit 20, and at a rear end opposite the front end the rack 52, a second handle 56 is attached.

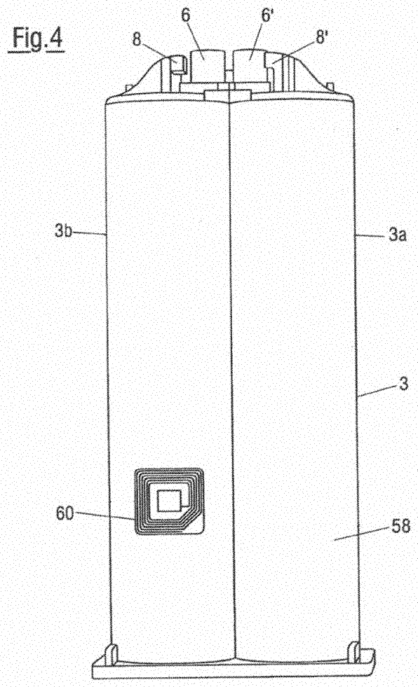

Since the first and second material dispensers 24′ are connected through the second handle 56 of the rack 52, one can further ensure that the first and second material dispensers 24′ move in unison. The dispenser 12 of the embodiment shown is generally used with a side-by-side cartridge 3, as shown in FIGS. 1 and 4. That is, the cartridge 3 contains two cartridge chambers 3a, 3b arranged next to one another. In this connection it should be noted that also so-called coaxial cartridges (not shown) could be used in the dispensing assembly, in this case only one plunger will be provided at the dispenser, with the plunger being configured to engage a so-called peeler piston.

An indicator 44 can be disposed on the handle 34 for indicating specific conditions. In other words, the indicator 44 can be an LED that indicates one or more of a number of specific conditions such as, temperature, pressure, first dispensing mode activated, second dispensing mode activated, low or full battery charge, overload (torque), high temperature, end-stop switch activated, etc. The indicator 44 can be any other suitable indicator or display to can display any suitable information.

A cartridge receptacle 14′ is disposed at a front end 48 of the housing 18 to receive a cartridge 3. Thus, the cartridge receptacle 14′ defines the front end 48 of the dispenser 12.

Such a dispensing assembly 70 comprising the dispenser 28, the cartridge 3 and the mixing tip 2′, 15′ enables materials to thoroughly mix and form an adhesive or mixed material right before or as they are being applied to a surface or area.

The drive unit 30 accommodates the motor 42 driving through a gear train with a cylindrical pinion gear meshing inside the drive unit 30 with the rack 52 to drive the latter.

The detector or sensor 31 is preferably one of one or more sensors that are configured to determine parameters relating to a current state of use of the dispenser 28 and/or of the cartridge contents stored in the cartridge 3. And/or of information relating to the mixing tip 2′, 15′ attached to the cartridge 3 of the dispensing assembly 70.

For example, the sensor 31 can be a temperature sensor that is arranged at the dispenser 28 and is configured to detect temperature data relating to a temperature of the environment in which the dispenser 28 is used, and/or a humidity sensor that is arranged in the dispenser 28 and is configured to detect humidity data relating to a humidity of the environment in which the dispenser 28 is used.

Moreover, if desired, the sensor 31 can be one of one or more sensors selected from a group including but not limited to a pressure sensor, a location sensor—in particular a GPS sensor—a gyroscopic sensor, a weight sensor, a strain sensor and combinations of the foregoing. In other words, the dispenser 28 can have a single sensor or a plurality of sensors that are configured to sense one or more of the conditions discussed herein.

In one embodiment, the sensor 31 can be disposed adjacent the rack 52 of the first and second material dispensers 34′ and/or disposed within the housing 29 and capable of detecting the movement of the material dispensers 24′ and/or the rack 52. However, it is noted that the sensor 31 can be disposed in any suitable position. Additionally, sensor 31 can be an optical sensor, sliding calipers or any suitable sensor that can determine the distance and/or speed of the movement of the material dispensers.

In one embodiment, the sensor 31 can be connected to the motor 42 and the controller 28, as illustrated in FIG. 3. Thus, the sensor 31 is capable of determining the speed of the material dispensers 24′ based on the speed of the motor 42.

The data from the sensor 31 can then be communicated to the controller 33 for purposes of controlling the speed and or distance of travel of the material dispensers 24′. In one embodiment, the sensor 31 enables the controller 33 to determine the speed and distance at which the material dispensers 24′ have travelled. However, it is noted that the sensor 31 can be any suitable sensor and not limited to the description provided herein.

The dispenser 28 can be capable of sending and receiving information wirelessly directly to both a remote device (not shown), such as a smartphone or a tablet and/or to a remote network terminal or server (e.g., the cloud also not shown). Moreover, the remote device can be capable of sending and receiving information wirelessly directly to both the dispenser 28 or to the remote network terminal or server (e.g., the cloud). The remote network terminal or server can be capable of sending and receiving information wirelessly directly to both the dispenser 28 or the remote device.

Regardless of the type of sensor, the data recorded via the sensor 31 can be collected and communicated via a wireless communication device to a remote device and/or to a remote network terminal or server.

As indicated in FIGS. 1 and 2 each of the mixing tips 2′, 15′ for mixing multi-component materials M, M′ comprises a readable code 12′ that is stored in or at the mixing tip 2′, 15′. The readable code 12′ indicates at least one of a type of mixing tip 2′, 15′, a manufacturer of the mixing tip 2′, 15′, a date of production of the mixing tip 2′, 15′, a length of the mixing tip 2′, 15′, a diameter of the mixing tip 2′, 15′, a size of the mixing tip 2′, 15′ and a list of materials compliant with the mixing tip 2′, 15′.

The code 12′ can be stored on a code storage element 12 that is embedded within the housing 7 (see FIGS. 1 and 2). As indicated in FIG. 3 a first code reader 31 is arranged at a front end of the receptacle 14′ of the dispenser 28. This code reader 31′ is adapted to read the code stored in or at the mixing tip 2′, 15′.

The code 12′ can be one of a hologram, a QR code, an NFC code, a barcode, and an RFID code. Likewise the code reader 31′ can be one of an RFID sensor, a barcode scanner, a hologram reader, and an NFC code reader. In the embodiments shown and discussed herein the codes 12′ and 60 are respective RFID codes and the code reader 31′ is an RFID sensor.

As further indicated in FIGS. 1 and 2 the respective mixing tip 2′, 15′ comprises a bottom housing part 11 surrounding the inlets 4, 4′ at the inlet end 5 with the code 12′ being arranged in the bottom housing part 11. The bottom housing part 11 is arranged adjacent to a tubular housing part 7′, with the tubular housing part 7′ tapering at the outlet end 10 towards the outlet 9.

Moreover, a length of the tubular housing part 7′ is at least 40%, preferably at least 60% of a distance between the outlet 10 and the inlets 4, 4′ along a longitudinal axis A of the mixing tip 2′, 15′.

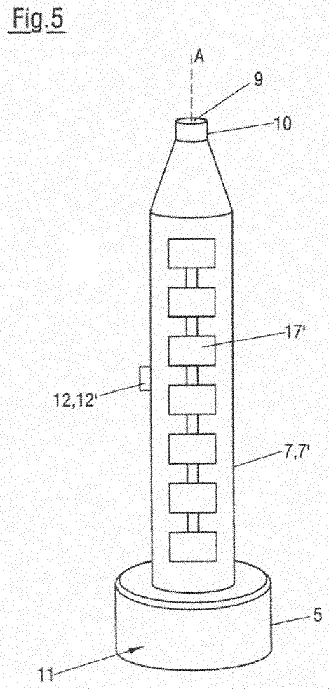

FIG. 5 shows a partial section through a mixing tip 2′ configured as a static mixer 2. The mixing element 17′ of the static mixer 2 is visible as is the code 12′ that is attached to an outer surface of the housing 7.

As also indicated in FIG. 5, the code 12′ is arranged at the tubular housing part 7′ of the housing 7. The tubular housing part 7′ of the mixing tip 2′, 15′ is configured to store and receive at least 30%, preferably at least 80% of the mixing element 17, 17′.

On manufacturing a mixing tip 2′, 15′, the method of manufacture comprises the steps of:

forming the mixing tip 2′, 15′ by one of injection molding the mixing tip 2′, 15′ and 3D printing the mixing tip 2′, 15′.

providing the code 12′ at or in the mixing tip 2′, 15′ before, during or after the step of forming said mixing tip 2′, 15′; and

validating the code 12′ following the completion of the mixing tip 2′, 15′.

If a cartridge 3 is installed in the dispenser 28 of FIG. 3 this results in a dispensing assembly 70 being formed, with the dispensing assembly 70 comprising a mixing tip 2′, a multi-component cartridge 3, filled with respective multi-component materials M, M′, the dispenser 28 and the controller 33. The dispenser 28 is adapted to bring about a dispensing of the multi-component materials M, M′ from the multi-component cartridge 3 via the mixing tip 2′, 15′, the dispenser 28 further comprising the code reader 31′ for reading the code 12′ stored in or at the mixing tip 2′, 15′, the controller 33 being connected to the code reader 31′ and being adapted to evaluate the code 12′ stored in or at the mixing tip 2′, 15′.

FIG. 4 shows a side by side multi-component cartridge 3. A cartridge code 60 is stored at a housing 58 of the multi-component cartridge 3. The cartridge code 60 indicates at least one of a material M, M′ of the multi-component cartridge 3, a volume of the multi-component material M, M′, a manufacturer of the multi-component cartridge 3, and a date of production of the multi-component cartridge 3.

The dispenser 28 shown in FIG. 3 comprises a second code reader 31′ arranged at the cartridge receptacle 14′, the second code reader 31′ being adapted to read out the cartridge code 60 and the controller 33 being adapted to evaluate the cartridge code 60.

In other designs the first and second code reads can be one and the same code reader 31′.

Generally speaking the controller 33 is adapted to output at least some of the information stored in the code 12′ and/or the cartridge code 60, e.g. via the indicator 44 or via a mobile phone, tablet or computer connected, preferably wirelessly to the dispenser 28. The indicator 44 respectively the mobile phone or tablet etc. is then configured to indicate the respective information stored in the code 12′ and the cartridge code 60 and to possibly also indicating if the correct mixing tip 2′, 15′ is installed at the cartridge 3 for use with the material M, M′ stored in said cartridge 3, i.e. whether the mixing tip 2′, 15′ installed at the cartridge 3 is suitable for use with the material M, M′ stored within the cartridge 3 in order to ensure the desired mixing results at the desired mixing efficiency.

On dispensing multi-component materials M, M′ using a mixing tip 2′, 15′ at a dispensing assembly 70 the following steps have to be carried out in preparation:

installing the multi-component cartridge 3 at the dispenser 28;

fixing the mixing tip 2′, 15′ to the multi-component cartridge 3;

reading out the code 12′ stored in or at the mixing tip 2′, 15′;

optionally reading out a cartridge code 60 stored in or at the multi-component cartridge 3; and

indicating at least some of the information stored in the code 12′ and/or the cartridge code 60 before a use of the dispenser 28.

1. A mixing tip for mixing multi-component materials (M, M′) exiting a multi-component cartridge, the mixing tip comprising:
an inlet end having a respective inlet for each of the multi-component materials, the inlet end being configured to be releasably coupled to the multi-component cartridge;
an outlet end having an outlet configured to dispense the mixed multi-component materials;
a mixing element arranged between the inlet end and the outlet end in a housing of the mixing tip, the mixing element being configured to mix the multi-component materials upon passage between the inlet end and the outlet end; and
a readable code is stored in or at the mixing tip the readable code indicating at least one of a type of mixing tip, a manufacturer of the mixing tip, a date of production of the mixing tip, a length of the mixing tip, a diameter of the mixing tip, a size of the mixing tip, a list of materials compliant with the mixing tip, a compatibility of the mixing tip with cartridge contents, and a list of applications compliant with the mixing tip.

2. The mixing tip in accordance with claim 1, wherein the code is stored at an element that is embedded within the housing or is attached to the housing of the mixing tip.

3. The mixing tip in accordance with claim 1, wherein the code is one of a hologram, a QR code, an NFC code, a barcode, and an RFID code.

4. The mixing tip in accordance with claim 1, wherein the mixing tip is one of a dynamic mixer and a static mixer.

5. The mixing tip in accordance with claim 1, wherein the mixing element is a one piece mixing element or a series of several separate mixing element segments combined to one mixing element in the housing of the mixing tip.

6. The mixing tip in accordance with claim 1, wherein the mixing tip comprises a bottom housing part surrounding the inlets at the inlet end with the code being arranged in or at the bottom housing part.

7. The mixing tip in accordance with claim 1, wherein the code is arranged in or at a tubular housing part of the housing, with the tubular housing part being configured to store and receive at least 30% of the mixing element, or
a length of the tubular housing part is at least 40% of a distance between the outlet and the inlets along a longitudinal axis of the mixing tip.

8. A method of manufacturing the mixing tip in accordance with claim 1, the method comprising:
forming the mixing tip;
providing the code at or in the mixing tip before, during or after the forming the mixing tip; and
validating the code following the completion of the mixing tip.

9. The method in accordance with claim 8, wherein the forming the mixing tip comprises one of injection molding the mixing tip and 3D printing the mixing tip.

10. A dispensing assembly comprising:
the mixing tip in accordance with claim 1;
a multi-component cartridge;
a dispenser; and
a controller, the dispenser configured to bring about dispensing of the multi-component materials from the multi-component cartridge via the mixing tip, the dispenser further comprising a code reader configured to read the code stored in or at the mixing tip, the controller being connected to the code reader and being configured to evaluate the code stored in or at the mixing tip.

11. The dispensing assembly in accordance with claim 10, wherein the controller is arranged at or in a housing of the dispenser.

12. The dispensing assembly in accordance with claim 10, wherein the multi-component cartridge further comprises a cartridge code stored in or at a housing of the multi-component cartridge, the cartridge code indicating at least one of a material of the multi-component cartridge, a volume of the multi-component material, a manufacturer of the multi-component cartridge, a date of production of the multi-component cartridge, a list of applications compliant with the cartridge, a list of mixing tips compliant with the cartridge, and a compatibility of the cartridge with the mixing tip, and the dispenser another code reader configured to read out the cartridge code and the controller being configured to evaluate the cartridge code.

13. The dispensing assembly in accordance with claim 10, wherein the controller is configured to output at least some of the information stored in the code or the cartridge code.

14. A method of dispensing the multi-component materials using in accordance with the dispensing assembly of claim 10, the method comprising:
installing the multi-component cartridge at the dispenser;
fixing the mixing tip to the multi-component cartridge;
reading out the code stored in or at the mixing tip; and
indicating at least some of the information stored in the code and/or the cartridge code before a use of the dispenser.

15. The method in accordance with claim 14, wherein the reading out the code stored in or at the mixing tip further comprises the reading out of a cartridge code.

16. The mixing tip in accordance with claim 1, wherein the mixing tip comprises a bottom housing part surrounding the inlets at the inlet end with the code being arranged in or at the bottom housing part, the bottom housing part being directly arranged adjacent to a tubular housing part, with the tubular housing part tapering at the outlet end towards the outlet.

17. The dispensing assembly in accordance with claim 10, wherein the multi-component cartridge is filled with respective multi-component materials

18. The dispensing assembly in accordance with claim 10, wherein the multi-component cartridge further comprises a cartridge code stored in or at a housing of the multi-component cartridge, the cartridge code indicating at least one of a material of the multi-component cartridge, a volume of the multi-component material, a manufacturer of the multi-component cartridge, a date of production of the multi-component cartridge, a list of applications compliant with the cartridge, a list of mixing tips compliant with the cartridge, and a compatibility of the cartridge with the mixing tip, the code reader configured to read out the cartridge code and the controller being configured to evaluate the cartridge code.
